(19) United States
(12) Patent Application Publication
(10) Pub. No.: US 2024/0363274 A1
(43) Pub. Date: Oct. 31, 2024

(54) FULLY-INTEGRATED VOLTAGE REGULATION MODULE INDUCTOR MAGNETIC SLURRY AND PREPARATION METHOD THEROF

(71) Applicant: HENGDIAN GROUP DMEGC MAGNETICS CO., LTD, Dongyang City Jinhua, Zhejiang (CN)

(72) Inventors: Leijie WANG, Dongyang City Jinhua, Zhejiang (CN); Yangdong YU, Dongyang City Jinhua, Zhejiang (CN); Quan ZHU, Dongyang City Jinhua, Zhejiang (CN); Jianyu CHEN, Dongyang City Jinhua, Zhejiang (CN); Kang YI, Dongyang City Jinhua, Zhejiang (CN)

(21) Appl. No.: 18/573,946

(22) PCT Filed: Mar. 30, 2023
(86) PCT No.: PCT/CN2023/085145

§ 371 Date: Dec. 22, 2023

(30) Foreign Application Priority Data
Apr. 11, 2022 (CN) 202210376268.X

(51) Int. Cl. H01F 1/153; H01F 1/33; H01F 41/02

(52) U.S. Cl. CPC H01F 1/15308; H01F 1/1535; H01F 1/33; H01F 41/0246

(57) ABSTRACT

Disclosed are a fully-integrated voltage regulation module inductor magnetic slurry and a preparation method thereof; in parts by mass, the components of the magnetic slurry comprise: 100 parts of a soft magnetic alloy powder, 9-13 parts of a binder and 2.85-4.61 parts of a curing agent; wherein the binder comprises bisphenol F epoxy resin and an aromatic reactive diluent; and the preparation method utilizes mechanical stirring and vacuum defoaming treatment to obtain a magnetic slurry having a suitable viscosity and good high-temperature resistance performance. The preparation method of the present application is simple in operation, has low preparation costs and is suitable for industrial manufacture.

### TECHNICAL FIELD

Examples of the present application relate to the technical field of magnetic materials, for example, a magnetic slurry for inductors used in fully integrated voltage regulators and a preparation method therefor.

### BACKGROUND

At present, the power supply systems for microprocessor modules of computers, servers and data centers are transforming from conventional voltage regulators to fully integrated voltage regulators (FIVRs) which have higher integration level, better power supply capacity and lower cost. Inductors in FIVRs are generally integrated into the package substrate, and the specific process is that a magnetic material is filled into through holes of the core layer of the package substrate, then through holes with a small diameter are formed in the magnetic material, and finally the through holes are coupled with one or more metal wires to realize the effect of inductance.

The inductors in FIVRs have a low inductance, which is generally tens of nanohenries, a very low direct-current resistance, a relatively high Q-value and a self-resonant frequency (up to 6 GHZ), and the heat dissipation problem of the microprocessor is considered at the same time, thus such inductors are required to keep a low power loss at high frequency, so that the magnetic material filled into the through holes is required to have a low loss at high frequency and good stability.

CN105741997A discloses a magnetic slurry, a preparation method therefor and a preparation method for a magnetic sheet. The magnetic slurry comprises a magnetic powder and an organic carrier, and the magnetic powder and the organic carrier have a mass ratio of 1:0.7-1:0.9; by mass percent, the organic carrier comprises 8-10% of a binder, 82-90% of a solvent, 0.1-1% of a defoaming agent, 0.1-1% of a dispersing agent and 1-6% of a plasticizer, the binder is polyvinyl butyral, and the solvent comprises an alcohol solvent and an ester solvent. The magnetic slurry employs the alcohol solvent and ester solvent with strong volatility, and meanwhile, the magnetic sheet prepared by the formula of the magnetic slurry cannot work in high temperature environment.

CN112679820A discloses a polyethylene-based injection-molded magnetic composite material for inductors and a preparation method therefor. The polyethylene-based injection-molded magnetic composite material for inductors is composed of 5-30% of a polyethylene-based material, 70-95% of a magnetic filler, 1-4% of a coupling agent and 1-4% of additives. And the polyethylene-based injection-molded magnetic composite material keeps mechanical strength while filled with a highly magnetic filler. However, the preparation method has a complex process, and the prepared soft magnetic composite material cannot work in high temperature environment.

CN111986866A discloses a high-frequency low-loss power-type soft magnetic composite material and a preparation method therefor. A slip casting process is used; trimethylolpropane triacrylate, an NiZn ferrite flaky powder, a permalloy spherical powder, dibutyl phthalate and acetone are mixed, and then vibrated in a ball mill to prepare a magnetic slurry with good fluidity, and the slurry is injected into a mold, heated, cured, and cooled to remove the mold to obtain the soft magnetic composite magnetic core. The magnetic core prepared from the high-frequency low-loss power-type soft magnetic composite effectively reduces the eddy current loss at high frequency, and the whole preparation process does not need external pressure, and the preparation process is simplified. However, after the trimethylolpropane triacrylate used as a polymer matrix, powder and other compounds are cured, the high-frequency low-loss power-type soft magnetic composite material has relatively poor high temperature resistance, and the acetone with high volatility is used as a solvent.

CN112125656A discloses a low-temperature cured high-frequency low-loss NiCuZn ferrite magnetic core material and a pressureless gel casting method. The 2.5 wt. % aqueous solution of methacrylamide monomers, N,N′-methylene bisacrylamide and 10 wt. % aqueous solution of a polyethylene glycol 400 plasticizer are mixed to prepare a premix, an NiCuZn ferrite powder is added to the premix to obtain a gelled slurry; the slurry is added with an ammonium persulfate aqueous solution and tetramethylethylenediamine, then injected into a mold, and cured at normal pressure and normal temperature and the mold was removed, and the blank is dried, finally sintered, and cooled to obtain a magnetic core. Via the high-frequency low-loss NiCuZn ferrite core material, the magnetic slurry can be cured at room temperature without external pressure. However, the used aqueous solutions will accelerate the oxidation of the alloy powder at a high temperature, resulting in performance deterioration, and the preparation method of the magnetic slurry is complicate.

Therefore, it has a great significance to develop a magnetic slurry for inductors used in fully integrated voltage regulators, which has a simple preparation method, low magnetic loss and good high temperature stability, and a preparation method therefor.

### SUMMARY

The following is a summary of the subject described herein. This summary is not intended to limit the protection scope of the claims.

An example of the present application provides a magnetic slurry for inductors used in fully integrated voltage regulators and a preparation method therefor. The magnetic slurry comprises a soft magnetic alloy powder, a binder and a curing agent in specific proportions, and the viscosity of the magnetic slurry is adjusted by an aromatic reactive diluent, so that the magnetic slurry has suitable viscosity and good high-temperature resistance; in the preparation method, a magnetic slurry with excellent performance is obtained by mechanical stirring and vacuum degassing, and the preparation method has a simple operation and good industrial application prospect.

In a first aspect, an example of the present application provides a magnetic slurry for inductors used in fully integrated voltage regulators, and the magnetic slurry comprises the following raw materials in parts by mass:
100 parts of a soft magnetic alloy powder, 9-13 parts of a binder and 2.85-4.61 parts of a curing agent;
the binder comprises a bisphenol F epoxy resin and an aromatic active diluent.

The aromatic reactive diluent in the magnetic slurry for inductors used in fully integrated voltage regulators of the present application adjusts the viscosity of the magnetic slurry, thereby giving the magnetic slurry good fluidity, and also avoids the appearance of pores and performance deterioration, which may be brought to the inductor prepared from the magnetic slurry by volatile organic solvent volatilizing with the increase of temperature when the volatile organic solvent is used as a raw material. When each raw material of the magnetic slurry in the present application is limited to a specific proportion range, the magnetic slurry has suitable viscosity and toughness, and can fully fill the through holes of the PCB, and the magnetic slurry in the through holes of the PCB has a good result of drilling without the cracking phenomenon, and the magnetic loss of the magnetic slurry is low. The glass transition temperature of the cured magnetic slurry in the present application is more than 150° C., which can ensure that the inductor of the fully integrated voltage regulator module can operate normally at a high temperature.

The magnetic slurry in the present application comprises (by mass) 9-13 parts of a binder, which may be, for example, 9 parts, 9.3 parts, 9.5 parts, 10 parts, 11 parts, 12 parts, 12.5 parts or 13 parts; however, the binder is not limited to the listed values, and other unlisted values within this value range are also applicable.

The magnetic slurry in the present application comprises (by mass) 2.85-4.61 parts of a curing agent, which may be, for example, 2.85 parts, 2.9 parts, 3 parts, 3.5 parts, 4 parts, 4.5 parts or 4.61 parts; however, the curing agent is not limited to the listed values, and other unlisted values within this value range are also applicable.

Preferably, the magnetic slurry comprises the following raw materials in parts by mass:
100 parts of the soft magnetic alloy powder, 10-12 parts of the binder and 3.17-4.25 parts of the curing agent; the binder is 10-12 parts, which may be, for example, 10 parts, 10.3 parts, 10.5 parts, 11 parts, 11.2 parts, 11.5 parts, 11.7 parts or 12 parts; however, the soft magnetic alloy powder is not limited to the listed values, and other unlisted values within this value range are also applicable; the curing agent is 3.17-4.25 parts, which may be, for example, 3.17 parts, 3.2 parts, 3.3 parts, 3.5 parts, 4 parts, 4.1 parts or 4.25 parts; however, the curing agent is limited to the listed values, and other unlisted values within this value range are also applicable.

Preferably, the soft magnetic alloy powder comprises an Fe-based amorphous alloy powder.

The soft magnetic alloy powder in the present application preferably comprises an Fe-based amorphous alloy powder, and the Fe-based amorphous alloy powder has excellent direct current superposition characteristic and low loss characteristic, so that the inductors used in fully integrated voltage regulators prepared by the magnetic slurry meet the requirement of keeping low loss at high frequency.

Preferably, the soft magnetic alloy powder has a particle size D50 of 1-4 μm, which may be, for example, 1 μm, 1.2 μm, 1.5 μm, 1.7 μm, 2 μm, 2.5 μm, 3 μm or 4 μm; however, the particle size is not limited to the listed values, and other unlisted values within this value range are also applicable.

Preferably, in the binder, the bisphenol F epoxy resin and the aromatic reactive diluent have a mass ratio of 2:1-1:2, which may be, for example, 2:1, 1.9:1.1, 1.7:1.5, 1.5:1.6, 1:1, 1.2:1.9 or 1:2; however, the mass ratio is not limited to the listed values, and other unlisted values within this value range are also applicable.

Preferably, the bisphenol F epoxy resin has an epoxide equivalent weight of 150-190 g/eq, which may be, for example, 150 g/eq, 155 g/eq, 160 g/eq, 170 g/eq, 180 g/eq or 190 g/eq; however, the epoxide equivalent weight is not limited to the listed values, and other unlisted values within this value range are also applicable.

Preferably, the bisphenol F epoxy resin has a viscosity of 2000-5000 cps at 25° C., which may be, for example, 2000 cps, 2300 cps, 2500 cps, 3000 cps, 3500 cps, 4000 cps, 4500 cps or 5000 cps; however, the viscosity is not limited to the listed values, and other unlisted values within this value range are also applicable.

Preferably, the aromatic reactive diluent has an epoxide equivalent weight of 100-140 g/eq, which may be, for example, 100 g/eq, 105 g/eq, 110 g/eq, 120 g/eq, 130 g/eq, 135 g/eq or 140 g/eq; however, the epoxide equivalent weight is not limited to the listed values, and other unlisted values within this value range are also applicable.

Preferably, the aromatic reactive diluent has a viscosity of 50-500 cps at 25° C., which may be, for example, 50 cps, 70 cps, 90 cps, 100 cps, 200 cps, 300 cps, 400 cps or 500 cps; however, the viscosity is not limited to the listed values, and other unlisted values within this value range are also applicable.

Preferably, the aromatic reactive diluent is a compound which has a benzene ring and one or more epoxy groups in the molecular structure.

Preferably, the curing agent comprises diethyltoluenediamine and/or isophorone diamine.

Preferably, the magnetic slurry has a viscosity of 40000-160000 cp, which may be, for example, 40000 cp, 50000 cp, 80000 cp, 100000 cp, 120000 cp, 140000 cp, 150000 cp or 160000 cp; however, the viscosity is not limited to the listed values, and other unlisted values within this value range are also applicable.

In a second aspect, an example of the present application provides a method for preparing the magnetic slurry for inductors used in fully integrated voltage regulators according to the first aspect, wherein the preparation method comprises the following steps:
a. mixing 9-13 parts by mass of a binder and 2.85-4.61 parts by mass of a curing agent, preforming a first stirring, then adding 100 parts by mass of a soft magnetic alloy powder, and preforming a second stirring to obtain a semi-finished magnetic slurry; and
b. subjecting the semi-finished magnetic slurry to vacuum degassing to obtain the magnetic slurry for inductors used in fully integrated voltage regulators.

In the method for preparing the magnetic slurry for inductors used in fully integrated voltage regulators in the present application, the liquid raw materials (the binder and the curing agent) are mixed by mechanical stirring, and then the solid soft magnetic alloy powder is added for stirring and mixing, so that the various raw materials are mixed evenly; then the semi-finished magnetic slurry is subjected to vacuum degassing to remove bubbles, avoiding the appearance of pores in the inductor prepared by the magnetic slurry from affecting the performance of the inductor. The preparation method has a simple operation and low preparation cost, which is suitable for industrial promotion and application.

Preferably, the first stirring in step (1) has a speed of 50-150 rpm, which may be, for example, 50 rpm, 80 rpm, 100 rpm, 110 rpm, 120 rpm, 140 rpm or 150 rpm; however, the speed is not limited to the listed values, and other unlisted values within this value range are also applicable.

Preferably, the first stirring is performed for 10-30 min, which may be, for example, 10 min, 12 min, 15 min, 20 min, 25 min or 30 min; however, the time is not limited to the listed values, and other unlisted values within this value range are also applicable.

Preferably, the first stirring and the second stirring are performed in a mechanical mixer.

Preferably, the second stirring has a speed of 50-200 rpm, which may be, for example, 50 rpm, 80 rpm, 100 rpm, 120 rpm, 150 rpm, 180 rpm or 200 rpm; however, the speed is not limited to the listed values, and other unlisted values within this value range are also applicable.

The speed of the second stirring in the present application is preferably 50-200 rpm, so that the liquid mixture of the binder and the curing agent is evenly mixed with the solid soft magnetic alloy powder. If the speed of the second stirring is too small, the raw materials are mixed unevenly, so that some regions of the through holes of the PCB have too much resin and large rigidity, and the magnetic slurry in the through holes of the PCB falls off during the drilling; moreover, the magnetic slurry is mixed unevenly, thus the degree of cure of the magnetic slurry is not enough, and the glass transition temperature is reduced to some extent, which will affect the performance of the inductors prepared by the magnetic slurry. Because the second stirring is performed in a mechanical mixer, an overly high stirring speed will increase the energy consumption and abrasion of the mechanical mixer, thereby increasing the preparation cost of the magnetic slurry.

Preferably, the second stirring is performed for 1-2 h, which may be, for example, 1 h, 1.2 h, 1.5 h, 1.7 h, 1.9 h, or 2 h; however, the time is not limited to the listed values, and other unlisted values within this value range are also applicable.

Preferably, the vacuum degassing in step (2) has a vacuum pressure of −0.07 to −0.1 MPa, which may be, for example, −0.07 MPa, −0.075 MPa, −0.08 MPa, −0.085 MPa, −0.09 MPa, −0.095 MPa or −0.1 MPa; however, the vacuum pressure is not limited to the listed values, and other unlisted values within this value range are also applicable.

The vacuum pressure of the vacuum degassing in the present application is preferably −0.07 to −0.1 MPa, which can remove bubbles from the magnetic slurry to the greatest extent and prevent the appearance of pores inside the cured magnetic slurry and its surface, thereby worsening the magnetic permeability and loss of the magnetic slurry.

Preferably, the vacuum degassing is performed for 10-30 min, which may be, for example, 10 min, 12 min, 15 min, 20 min, 25 min or 30 min; however, the time is not limited to the listed values, and other unlisted values within this value range are also applicable.

As a preferred technical solution of the present application, the preparation method comprises the following steps:
a. mixing 9-13 parts by mass of a binder and 2.85-4.61 parts by mass of a curing agent, preforming a first stirring at a speed of 50-150 rpm for 10-30 min, then adding 100 parts by mass of a soft magnetic alloy powder, and preforming a second stirring at a speed of 50-200 rpm for 1-2 h to obtain a semi-finished magnetic slurry; and
b. subjecting the semi-finished magnetic slurry to vacuum degassing at a vacuum pressure of −0.07 to −0.1 MPa for 10-30 min to obtain the magnetic slurry for inductors used in fully integrated voltage regulators.

In a third aspect, an example of the present application also provides an application of the magnetic slurry for inductors used in fully integrated voltage regulators according to the first aspect for preparing inductors used in fully integrated voltage regulators.

Compared with the related art, the examples of the present application have at least the following beneficial effects:
a. the magnetic slurry for inductors used in fully integrated voltage regulators provided by the examples of the present application has low magnetic loss, suitable viscosity and good high-temperature resistance, and the glass transition temperature of the magnetic slurry is more than or equal to 150° C., which ensures that the inductor prepared by the magnetic slurry can operate normally at a high temperature; and
b. the method for preparing the magnetic slurry for inductors used in fully integrated voltage regulators provided by the examples of the present application has a simple operation and low preparation cost, which is suitable for industrial promotion and application.

After reading and understanding detailed descriptions, other aspects can be understood.

### DETAILED DESCRIPTION

For facilitate the understanding of the present application, the examples are described below. It should be understood by those skilled in the art that the examples are only to help understand the present application and should not be regarded as a specific limitation of the present application.

The present application is further described in detail below. However, the following examples are only simple examples of the present application, and do not represent or limit the protection scope of the claims, and the protection scope of the present application is defined by the claims.

Raw materials including an Fe-based amorphous alloy powder, a bisphenol F epoxy resin, an aromatic reactive diluent TDS_REP-137, diethyltoluenediamine and isophorone diamine in the following examples and comparative examples are commercially available.

### Example 1

This example provides a magnetic slurry for inductors used in fully integrated voltage regulators, and the magnetic slurry comprises the following raw material components in parts by mass: 100 parts of an Fe-based amorphous alloy powder, 10 parts of a binder and 3.17 parts of a curing agent of diethyltoluenediamine; the binder is a bisphenol F epoxy resin and an aromatic reactive diluent TDS_REP-137 with a mass ratio of 1:1.

The Fe-based amorphous alloy powder has a particle size D50 of 2 μm; the bisphenol F epoxy resin has an epoxy equivalent weight of 180 g/eq and a viscosity of 3000 cps at 25° C.; the aromatic reactive diluent has an epoxy equivalent weight of 130 g/eq and a viscosity of 100 cps at 25° C.

This example also provides a method for preparing the magnetic slurry for inductors used in fully integrated voltage regulators, and the preparation method comprises the following steps:
a. 10 parts by mass of a binder and 3.17 parts by mass of a curing agent were mixed, and subjected to a first stirring at a speed of 50 rpm for 20 min, and then 100 parts by mass of a Fe-based amorphous alloy powder was added and subjected to a second stirring at a speed of 100 rpm for 1 h, and a semi-finished magnetic slurry was obtained; and
b. the semi-finished magnetic slurry was subjected to vacuum degassing at a vacuum pressure of −0.09 MPa for 30 min, and the magnetic slurry for inductors used in fully integrated voltage regulators was obtained.

### Example 2

This example provides a magnetic slurry for inductors used in fully integrated voltage regulators, and the raw material components of the magnetic slurry are the same as in Example 1 except that the binder is 9 parts by weight and the curing agent is 2.85 parts by weight.

This example also provides a method for preparing the magnetic slurry for inductors used in fully integrated voltage regulators, and the preparation method is the same as in Example 1.

### Example 3

This example provides a magnetic slurry for inductors used in fully integrated voltage regulators, and the raw material components of the magnetic slurry are the same as in Example 1 except that the binder is 13 parts by weight and the curing agent is 4.25 parts by weight.

This example also provides a method for preparing the magnetic slurry for inductors used in fully integrated voltage regulators, and the preparation method is the same as in Example 1.

### Example 4

This example provides a magnetic slurry for inductors used in fully integrated voltage regulators, and the raw material components of the magnetic slurry are the same as in Example 1 except that the bisphenol F epoxy resin and the aromatic reactive diluent in the binder has a mass ratio of 2:1.

This example also provides a method for preparing the magnetic slurry for inductors used in fully integrated voltage regulators, and the preparation method is the same as in Example 1.

### Example 5

This example provides a magnetic slurry for inductors used in fully integrated voltage regulators, and the raw material components of the magnetic slurry are the same as in Example 1 except that the bisphenol F epoxy resin and the aromatic reactive diluent in the binder has a mass ratio of 1:2.

This example also provides a method for preparing the magnetic slurry for inductors used in fully integrated voltage regulators, and the preparation method is the same as in Example 1.

### Example 6

This example provides a magnetic slurry for inductors used in fully integrated voltage regulators, and the raw material components of the magnetic slurry are the same as in Example 1.

This example also provides a method for preparing the magnetic slurry for inductors used in fully integrated voltage regulators, and the preparation method is the same as in Example 1 except that the speed of the second stirring is changed to 40 rpm.

### Example 7

This example provides a magnetic slurry for inductors used in fully integrated voltage regulators, and the raw material components of the magnetic slurry are the same as in Example 1.

This example also provides a method for preparing the magnetic slurry for inductors used in fully integrated voltage regulators, and the preparation method is the same as in Example 1 except that the vacuum pressure of vacuum degassing is changed to −0.05 MPa.

### Comparative Example 1

This comparative example provides a magnetic slurry for inductors used in fully integrated voltage regulators, and the raw material components of the magnetic slurry are the same as in Example 1 except that the binder is 5 parts by weight.

This comparative example also provides a method for preparing the magnetic slurry for inductors used in fully integrated voltage regulators, and the preparation method is the same as in Example 1.

### Comparative Example 2

This comparative example provides a magnetic slurry for inductors used in fully integrated voltage regulators, and the raw material components of the magnetic slurry are the same as in Example 1 except that the binder is only a bisphenol F epoxy resin.

This comparative example also provides a method for preparing the magnetic slurry for inductors used in fully integrated voltage regulators, and the preparation method is the same as in Example 1.

### Comparative Example 3

This comparative example provides a magnetic slurry for inductors used in fully integrated voltage regulators, and the raw material components of the magnetic slurry are the same as in Example 1 except that the binder is only an aromatic reactive diluent.

This comparative example also provides a method for preparing the magnetic slurry for inductors used in fully integrated voltage regulators, and the preparation method is the same as in Example 1.

### Comparative Example 4

This comparative example provides a magnetic slurry for inductors used in fully integrated voltage regulators, and the raw material components of the magnetic slurry are the same as in Example 1 except that the binder is only a conventional reactive diluent of n-butyl glycidyl ether.

This comparative example also provides a method for preparing the magnetic slurry for inductors used in fully integrated voltage regulators, and the preparation method is the same as in Example 1.
i. The viscosity of the magnetic slurry in the examples and comparative examples is tested.

The viscosity of the magnetic slurry is tested using the DV2T viscometer from BROOKFIELD, and the results are shown in Table 1.

The magnetic slurry in the examples and comparative examples is poured into the through holes of PCB, and the PCB filled with the magnetic slurry is cured by stages according to a procedure of 80° C./(1-2) h+100° C./(1-2) h+125° C./(1-2) h+150° C./2 h.

2. The condition of the magnetic slurry in the examples and comparative examples in the through holes of the PCB is evaluated.

The condition of the cured magnetic slurry in the through holes of the PCB is observed by a microscope to inspect whether the through holes is fully filled. The through holes of the PCB for testing have a thickness of 4 mm and hole diameters of 1 mm, 1.5 mm and 2 mm, respectively.

3. The drilling result of the magnetic slurry in the examples and comparative examples in the through holes of the PCB is evaluated.

The PCB filled with cured magnetic slurry is fixed, and the magnetic slurry in the through holes of the PCB is drilled through. The drilling holes are observed by a microscope to check whether there are problems such as cracking and corner-chipping.

4. The glass transition temperature of the magnetic slurry in the examples and comparative examples is evaluated.

The magnetic slurry is poured into an 8 mm×8 mm×5 mm mold, cured and then naturally cooled, and the mold is removed. The glass transition temperature is measured by a thermomechanical analyzer (TMA).

5. The magnetic permeability of the magnetic slurry in the examples and comparative examples is evaluated.

The magnetic slurry is poured into a mold with an outer diameter of 20 mm, an inner diameter of 10 mm and a thickness of 5 mm, cured and then naturally cooled, and the mold is removed. The real part μ′ and imaginary part μ″ are measured at 80 MHz by the Agilent E4991A analyzer, and the loss tan δ=μ″/μ′ is calculated.

The condition of the magnetic slurry in the through holes of the PCB, the drilling result of the magnetic slurry in the through holes of the PCB, the glass transition temperature and the magnetic permeability are shown in Table 1.

TABLE 1

| | | Condition of | Drilling result | | | |
|---|---|---|---|---|---|---|
| | | the magnetic | of the magnetic | Glass | | |
| | | slurry in | slurry in | transition | | |
| | Viscosity | through holes | through holes | temperature | | |
| | (cp) | of PCB | of PCB | (° C.) | μ′/μ″ | tanδ |
| Example 1 | 86200 | Fully filled | Good | 162.7 | 6.683/0.129 | 0.0193 |
| Example 2 | 104600 | Fully filled | Good | 161.4 | 6.857/0.157 | 0.0229 |
| Example 3 | 52300 | Fully filled | Good | 163.1 | 5.971/0.102 | 0.0171 |
| Example 4 | 93100 | Fully filled | Good | 172.3 | 6.502/0.124 | 0.0191 |
| Example 5 | 74300 | Fully filled | Good | 155.6 | 6.741/0.134 | 0.0199 |
| Example 6 | 88320 | Fully filled | Falling off in | 137.7 | 6.711/0.131 | 0.0195 |
| | | | some regions | | | |
| Example 7 | 75690 | Observing pores | Pores in | 157.3 | 6.323/0.145 | 0.0229 |
| | | on the surface | some regions | | | |
| Comparative | 213000 | Deficiently | Good | 163.1 | 7.531/0.271 | 0.0360 |
| Example 1 | | filled | | | | |
| Comparative | 194000 | Deficiently | Good | 179.8 | 6.303/0.117 | 0.0186 |
| Example 2 | | filled | | | | |
| Comparative | 63100 | Fully filled | Corner- | 151.9 | 7.114/0.150 | 0.0211 |
| Example 3 | | | chipping | | | |
| Comparative | 79300 | Fully filled | Good | 126.6 | 6.701/0.133 | 0.0198 |
| Example 4 | | | | | | |

As can be seen from Table 1:
a. it can be seen from Examples 1-5 that the viscosity of the magnetic slurry for inductors used in fully integrated voltage regulators provided by the present application is within the range of 40000-160000 cp, the through holes of the PCB can be fully filled, and the magnetic slurry in the through holes of the PCB has a good drilling result without corner-chipping; the glass transition temperature is more than or equal to 150° C., and the magnetic loss can be less than or equal to 0.0230; by the comparison of various properties of Example 1, Example 2 and Example 3, it can be seen that with the decrease of the proportion of binder, the viscosity is increased to some extent, and the real part of the magnetic permeability and magnetic loss of the magnetic slurry are increased to some extent; by the comparison of various properties of Example 1, Example 4 and Example 5, it can be seen that the greater the proportion of the bisphenol F epoxy resin, the higher the viscosity of the magnetic slurry;
b. it can be seen from Example 1 and Example 6 that the speed of the second stirring in Example 1 is 50 rpm, and the speed of the second stirring in Example 6 is 40 rpm and comparatively low, resulting in a uneven mixing of the magnetic slurry, so that some regions of the through holes of the PCB have too much resin as well as a large rigidity, and thus the magnetic slurry in the through holes of the PCB falls off during the drilling; in addition, because the magnetic slurry is not evenly mixed, the degree of cure of the cured magnetic slurry is not enough, so that the glass transition temperature is reduced to some extent;
c. it can be seen from Example 1 and Example 7 that the vacuum pressure of the vacuum degassing in Example 1 is-0.09 MPa, and the vacuum pressure of the vacuum degassing in Example 7 is-0.05 MPa and comparatively low, so that bubbles inside the magnetic slurry cannot be completely discharged, directly resulting in the appearance of pores inside the cured magnetic slurry and on its surface, thereby worsening the magnetic permeability and loss of the magnetic slurry;
d. it can be seen from Example 1 and Comparative Example 1 that in Example 1, the binder is 10 parts by weight, the viscosity of the prepared magnetic slurry is 86200 cp, the magnetic slurry can fully fill the through holes of the PCB, and the magnetic slurry in the through holes of the PCB has a good drilling result without corner-chipping, and the magnetic loss is only 0.0193; the parts by mass of the solid raw material, the Fe-based amorphous alloy powder, remain unchanged in Comparative Example 1, while the parts by mass of the binder decrease, which means that the liquid for the solid is less, and consequently the obtained magnetic slurry has an increased viscosity, which cannot completely fill the through holes of the PCB, and the magnetic loss is also increased at the same time; it is shown that in the present application, the raw materials of the magnetic slurry are limited to contain: 100 parts by mass of a soft magnetic alloy powder, 9-13 parts by mass of a binder and 2.85-4.61 parts by mass of a curing agent, ensuring that the magnetic slurry has suitable viscosity and low magnetic loss; and
e. it can be seen from Example 1 and Comparative Examples 2-4 that in Example 1, the binder in Example 1 is a bisphenol F epoxy resin and an aromatic reactive diluent with a mass ratio of 1:1, the viscosity of the prepared magnetic slurry is 86200 cp, the magnetic slurry can fully fill the through holes of the PCB, and the magnetic slurry in the through holes of the PCB has a good drilling result without corner-chipping, and the magnetic loss is only 0.0193; in Comparative Example 2, when only the bisphenol F epoxy resin is used as a binder, the viscosity of the magnetic slurry is high, which leads to the result that the through holes of the PCB cannot be completely filled; in Comparative Example 3, when only the aromatic reactive diluent is used as a binder, the cured magnetic slurry has a large brittleness, and the corner-chipping phenomenon is extremely liable to occur during the drilling; in Comparative Example 4, the conventional reactive diluent of n-butyl glycidyl ether is used, and the glass transition temperature of the obtained magnetic slurry is only 126.6° C., which cannot meet the needs of working at a high temperature; it is shown that in the present application, the magnetic slurry prepared by the binder which is made by mixing the bisphenol F epoxy resin and the aromatic reactive diluent has suitable viscosity and good high temperature resistance.

In summary, the magnetic slurry for inductors of fully integrated voltage regulators provided by the present application has low magnetic loss, suitable viscosity and good high temperature resistance, and its glass transition temperature is more than or equal to 150° C., which can ensure that the inductor prepared by the magnetic slurry can be operated normally at a high temperature; the preparation method has a simple operation and low preparation cost, which is suitable for industrial promotion and application.

The applicant declares that the above is only specific embodiments of the present application, and the protection scope of the present application is not limited thereto. Those skilled in the art should understand that within the technical scope disclosed by the present application, any change or replacement, which is easily thought of by a person skilled in the art, shall fall within the protection scope and disclosure scope of the present application.

What is claimed is:

1. A magnetic slurry for inductors used in fully integrated voltage regulators, which comprises the following raw materials in parts by mass:
100 parts of a soft magnetic alloy powder, 9-13 parts of a binder and 2.85-4.61 parts of a curing agent;
wherein the binder comprises a bisphenol F epoxy resin and an aromatic reactive diluent.

2. The magnetic slurry according to claim 1, wherein the magnetic slurry comprises the following raw materials in parts by mass:
100 parts of the soft magnetic alloy powder, 10-12 parts of the binder and 3.17-4.25 parts of the curing agent.

3. The magnetic slurry according to claim 1, wherein the soft magnetic alloy powder comprises an Fe-based amorphous alloy powder.

4. The magnetic slurry according to claim 1, wherein the soft magnetic alloy powder has a particle size D50 of 1-4 μm.

5. The magnetic slurry according to claim 1, wherein the bisphenol F epoxy resin and the aromatic reactive diluent in the binder have a mass ratio of 2:1-1:2.

6. The magnetic slurry according to claim 1, wherein the magnetic slurry has a viscosity of 40000-160000 cp.

7. A method for preparing the magnetic slurry for inductors used in fully integrated voltage regulators according to claim 1, comprising the following steps:
(1) mixing 9-13 parts by mass of a binder and 2.85-4.61 parts by mass of a curing agent, preforming a first stirring, then adding 100 parts by mass of a soft magnetic alloy powder, and preforming a second stirring to obtain a semi-finished magnetic slurry; and
(2) subjecting the semi-finished magnetic slurry to vacuum degassing to obtain the magnetic slurry for inductors used in fully integrated voltage regulators.

8. The preparation method according to claim 7, wherein the first stirring in step (1) has a speed of 50-150 rpm.

9. The preparation method according to claim 7, wherein the first stirring is performed for 10-30 min.

10. The preparation method according to claim 7, wherein the second stirring has a speed of 50-200 rpm.

11. The preparation method according to claim 7, wherein the second stirring is performed for 1-2 h.

12. The preparation method according to claim 7, wherein the vacuum degassing in step (2) is performed at a vacuum pressure of −0.07 to −0.1 MPa.

13. The preparation method according to claim 7, wherein the preparation method comprises the following steps:
(1) mixing 9-13 parts by mass of a binder and 2.85-4.61 parts by mass of a curing agent, preforming a first stirring at a speed of 50-150 rpm for 10-30 min, then adding 100 parts by mass of a soft magnetic alloy powder, and preforming a second stirring at a speed of 50-200 rpm for 1-2 h to obtain a semi-finished magnetic slurry; and
(2) subjecting the semi-finished magnetic slurry to vacuum degassing at a vacuum pressure of −0.07 to −0.1 MPa for 10-30 min to obtain the magnetic slurry for inductors used in fully integrated voltage regulators.

14. (canceled)

16. The magnetic slurry according to claim 1, wherein the bisphenol F epoxy resin has a viscosity of 2000-5000 cps at 25° C.

17. The magnetic slurry according to claim 1, wherein the aromatic reactive diluent has an epoxide equivalent weight of 100-140 g/eq.

18. The magnetic slurry according to claim 1, wherein the aromatic reactive diluent has a viscosity of 50-500 cps at 25° C.

19. The magnetic slurry according to claim 1, wherein the aromatic reactive diluent is a compound which has a benzene ring and one or more epoxy groups in the molecular structure.

20. The magnetic slurry according to claim 1, wherein the curing agent comprises diethyltoluenediamine and/or isophorone diamine.

21. The preparation method according to claim 7, wherein the vacuum degassing is performed for 10-30 min.
